(19) United States
(12) Patent Application Publication
(10) Pub. No.: US 2005/0187496 A1
(43) Pub. Date: Aug. 25, 2005

(54) Motorized foot caring and massage device

(75) Inventor: Ka Nam Ho, Hong Kong (CN)

Correspondence Address: SUGHRUE MION, PLLC, 2100 PENNSYLVANIA AVENUE, N.W., SUITE 800, WASHINGTON, DC, 20037, US

(73) Assignee: KWONNIE ELECTRICAL PRODUCTS LIMITTED

(21) Appl. No.: 10/973,346

(22) Filed: Oct. 27, 2004

(30) Foreign Application Priority Data
Feb. 23, 2004 (CN) 200410006883.3

(51) Int. Cl. A47K 3/022; A61H 35/00

(52) U.S. Cl. 601/15; 601/22; 601/158; 4/622; 601/166; 607/86

(57) ABSTRACT

The present invention provides a motorized foot caring and massage device(MFCMD), comprising a container provided in a housing, the container having a bottom portion and used for containing water; an air pump, heating means, a vibration assembly and a motorized driven system being provided under the bottom portion of the container; and a function selection switch provided on the housing, in which an upwardly raised peninsular foot seat is provided at a central portion of the container, a combination of stone massage means and raised nodes is provided at a front end of a top portion of the foot seat, and replaceable rotatable massage attachments are provided at a rear end of the top portion of the foot seat; a double safety system is provided under the bottom portion of the container, including a sealing system and a drainage system, the sealing system is used for maintaining the rotation of the output shaft and sealing under normal condition, the drainage system is used for preventing water contained in the container from leaking and entering into the means provided under the bottom of the container in case of failure of the sealing system. The foot caring and massage device of the present invention perfects the functions and guarantees safe and reliable operation.

### TECHNICAL FIELD OF THE INVENTION

The present invention introduces a motorized foot caring and massage device for providing various targeted or comprehensive caring and massage therapy functions to the human feet. The motorized foot caring device comprises a container provided in a housing, the container having a bottom portion and used for containing water; an air pump, heating means, a vibration assembly and a motorized driven system being provided under the bottom portion of the container; and a function selection switch provided on the housing.

### THE BACKGROUND ART

Various devices/apparatuses made and utilized as therapeutic caring device for the feet are known. For example, there are devices for providing heat and vibration therapy and caring to the feet, in which the devices provide vibration massage to the feet by vibration of the massage device and provide heat caring to the feet using the water heated by an electric heating means. In addition to heat caring and vibratory massage, some foot massage devices can also produce bubbles in the water contained in the container so as to provide bubble massage to the feet.

In order to provide targeted or comprehensive caring and therapy to the feet, there is an urgent demand for a multifunctional foot caring and therapy device. In this connection, the U.S. Pat. No. 6,385,795 and U.S. Pat. No. 6,393,633 disclose a foot bathing device, which comprises a container for containing water and an upwardly raised peninsular foot seat provided at a central portion of the container, wherein stationary, movable or rotatable massage attachments are provided on the bottom portion of the container, a replaceable massage attachment is provided at the front end of the foot seat, and a heating element provided at the rear end of the foot seat.

In addition, the U.S. Pat. No. 6,405,390 discloses a multifunctional foot bathing device, wherein a replaceable massage attachment is provided only at the rear end of the foot seat.

However, the above foot caring and massage devices can not fully meet the more comprehensive and targeted foot caring and massage therapy demand of the user. Further, the above documents never disclose any contents concerning leaking prevention.

### BRIEF SUMMARY OF THE INVENTION

An object of the present invention is to provide a motorized foot caring and massage device, which improves the foot caring and massage functions and is capable of providing corresponding safety protection.

To achieve the object of the present invention, there is provided a motorized foot caring and massage device comprising a container provided in a housing, the container having a bottom portion and used for containing water; an air pump, heating means, a vibration assembly and a motorized driven system being provided under the bottom portion of the container; and a function selection switch provided on the housing,
wherein raised nodes and massage ribs are provided on the bottom portion of the container for providing reflexology massage to the sole of the feet, and rotatable massage attachments which are replaceable as desired are provided in the recess formed on the bottom portion of the container;
the air pump directs air into the container through holes formed in the massage ribs, thereby generating air bubbles in the water contained in the container;
the heating means is used for heating the water contained in the container and maintaining a temperature of the water;
wherein an upwardly raised peninsular foot seat is provided at a central portion of the container, a combination of stone massage means and raised nodes is provided at a front end of a top portion of the foot seat, and the rotatable massage attachments which are replaceable as desired are provided at a rear end of the top portion of the foot seat;
wherein the motorized driven system includes a motor, an output shaft and a gear system driven by the motor, the motorized driven system is used for driving the rotatable massage attachments provided at the bottom portion of the container and at the foot seat to rotate;
wherein the vibration assembly includes an eccentric boss provided on the output shaft of the motor, and is used for generating vibration and transmitting the vibration to the raised nodes provided at the bottom portion of the container and at the foot seat;
wherein a double safety system is provided under the bottom portion of the container, the double safety system includes a sealing system and a drainage system, the sealing system is used for maintaining the rotation of the output shaft and sealing under normal condition, the drainage system is used for preventing water contained in the container from leaking and entering into the means provided under the bottom of the container in case of failure of the sealing system;
the function selection switch is provided for selecting various combinations of foot caring therapy functions as desired.

According to further aspect of the present invention, the heating means comprises electric heating wires.

According to further aspect of the present invention, the rotatable massage attachments are of roller type or disc type.

According to further aspect of the present invention, the stone massage means is of oval shape and provided substantially at a center portion of the combination of the stone massage means massage means and the raised nodes.

According to further aspect of the present invention, the rotatable massage attachments provided on the top of the foot seat can be manually rotated by friction between a rear portion of a sole of foot and the massage attachments or be motorized rotated by the motorized driving system.

According to further aspect of the present invention, the rotatable massage attachments provided on the top of the foot seat have a shape of bossed disc, impeller, vane wheel, flat disc or brush.

According to further aspect of the present invention, the function selection switch is a rotary switch or a button switch.

According to further aspect of the present invention, wherein the function selection switch can be used to select various combinations of the foot caring functions comprising Vibration+Heat+Motorized Massage, Bubble+heat or Vibration+heat+bubble+Motorized massage.

According to further aspect of the present invention, a top cover made of transparent plastic material, which covers the massage device for protection when the massage device is not used.

According to further aspect of the present invention, rubber feet at the bottom side of the housing for supporting the massage device, the rubber feet are fastened to a bottom side of the housing by screws.

The motorized foot caring and massage device of the present invention can provide various targeted care and therapy to the feet such as the “bubble”, “heat”, “vibration”, and “massage” therapy to the feet. In addition, it can provide the “stone” therapy and “motorized rotation” massage therapy to the feet. The present invention is capable of providing not only the targeted therapy but also comprehensive foot caring therapy to the feet. The massage attachments are driven to rotate by the motorized driven system and employ a double safety system, which can guarantee the safety and reliable operation of the device. The motorized driven system is provided under the bottom of the container, comprising a motor and a gear system, and the motorized driven system is used for rotating the massage attachments so as to provide massage to the feet when the feet contact the massage attachments. The air pump is provided under the bottom portion of the container, air coming from the air pump is directed into the container through the holes formed in the massage ribs, thereby generating bubbles in the liquid contained in the container. The heating means is used for heating the water contained in the container. The double safety system comprises a sealing system and a drainage system and is provided at and under the bottom portion of the container. The sealing system is used for maintaining rotation of the output shaft and sealing under normal condition, and the drainage system is used for preventing water contained in the container from leaking and entering into the means provided under the bottom of the container in case of failure of the sealing system.

The present invention has improved foot massage function, that is, when the foot is seated on the foot seat, the front portion and the rear portion of the sole of the foot can be cared and massaged simultaneously respectively through the combination of the stone massage means and raised nodes provided at the front end of the foot seat and the rotatable massage attachments provided at the rear end of the foot seat; and the safety and reliable operation of the massage device can be guaranteed by the double safety system.

### BRIEF DESCRIPTION OF THE DRAWINGS

The above objects and other objects, features and advantages of the present invention are readily apparent from the following detailed description of the preferred embodiments of the present invention in connection with the accompanying drawings, in which:

FIG. 1 is a perspective view the motorized foot caring and massage device according to an embodiment of the present invention;

FIG. 2 is a top plan view of the motorized foot caring and massage device of FIG. 1;

FIG. 3 is a front view of the motorized foot caring and massage device of FIG. 1, showing a user's foot being massaged by the raised nodes, the stone massage means and the massage attachments provided on the foot seat;

FIG. 4 is a perspective view of the motorized foot caring and massage device similar to FIG. 1, wherein the wall structure of the housing is partially cut away so as to clearly show a user's foot which is being massaged by the roller attachments provided on the bottom portion of the container;

FIG. 5 is a view of showing the air pump, heating means, vibration assembly and motorized driven system located under the bottom of the container;

FIG. 6A and 6B are a partial perspective view and a partial section view showing the portion under the bottom of the container respectively, wherein the double safety system is especially shown;

FIG. 7A is a view showing the roller attachments installed at the bottom of the container;

FIG. 7B is a view showing the recess provided at the bottom of the container for installing the roller attachments;

FIG. 7C is a perspective exploded view of the roller attachments, the roller attachment bracket and transmission gear;

FIG. 7D is a view showing the raised massage attachments installed at the bottom of the container;

FIG. 7E is a view showing the recess provided at the bottom of the container for installing the raised massage attachments;

FIG. 7F is a view showing the raised massage attachments, the raised massage attachments seat and transmission gear;

FIG. 8 is a view showing the selection switch and ON/OFF switch provided on the housing;

FIG. 9 is a view showing different rotatable massage attachments driven manually and driven by motorized system.

### DETAILED DESCRIPTION OF THE PREFERRED EMBODIMENTS

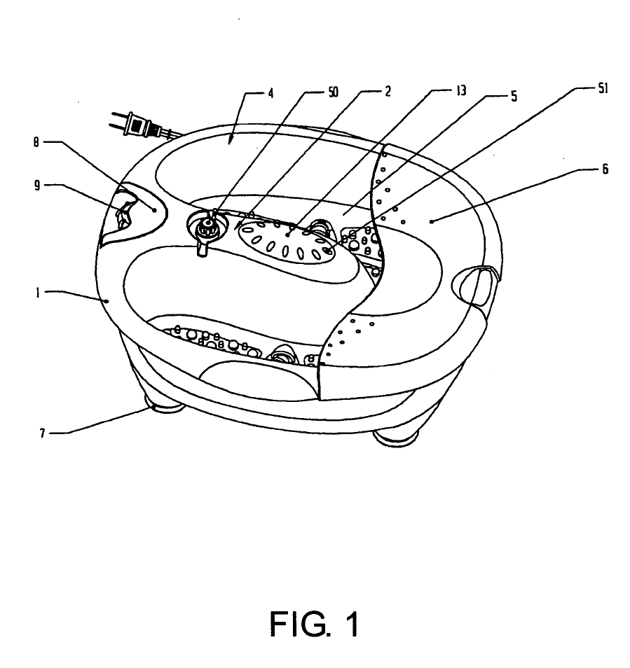

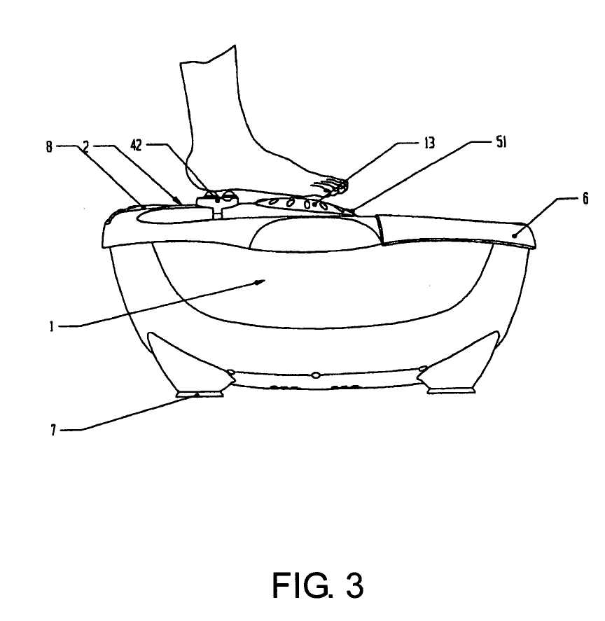

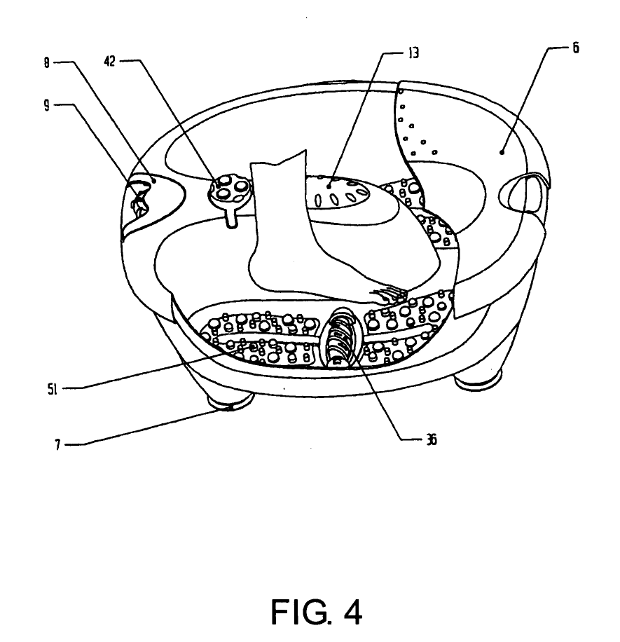

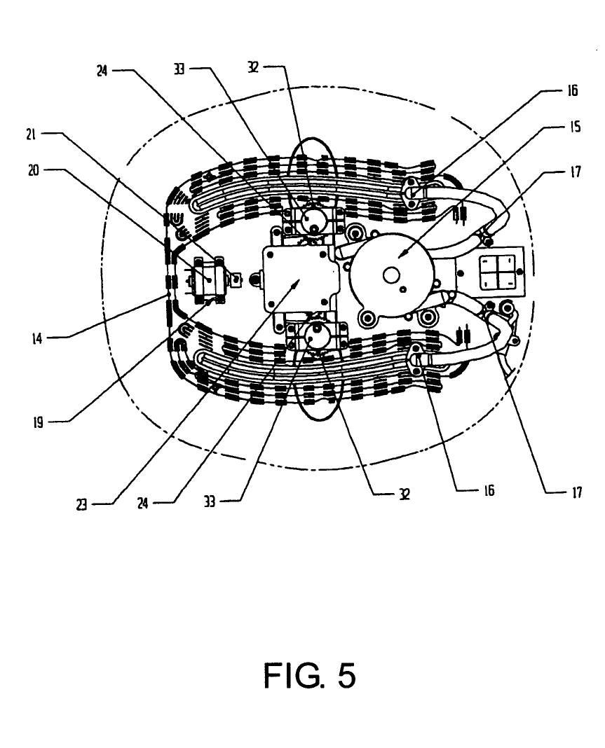

FIGS. 1-5 show a motorized foot caring and massage device according to the present invention, which can be used to provide heat, vibration, massage, bubbles caring and massage and combinations thereof to the feet. The motorized foot caring and massage device mainly comprises a housing 1, a container 4 provided in the housing, an upwardly raised peninsular foot seat 2 provided at a central portion of the container, and a top cover 6.

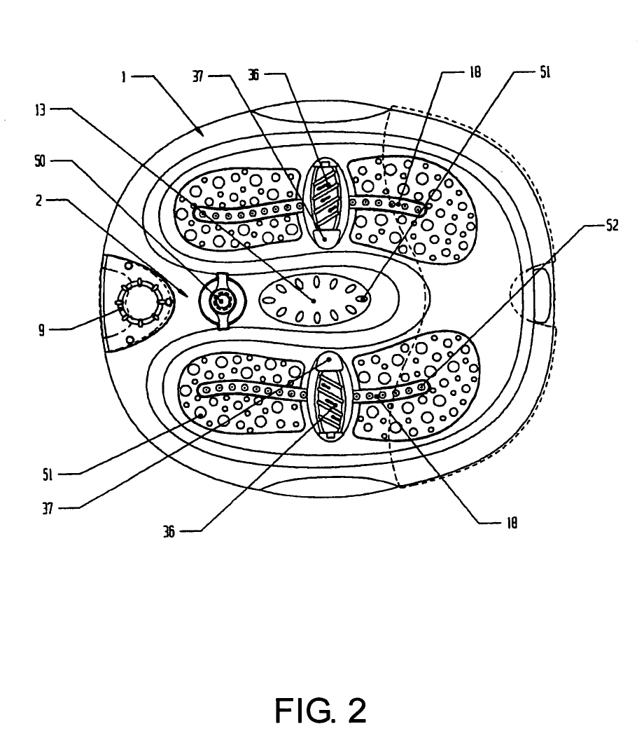

As shown in the Figs, the container 4 comprises an upwardly-extended wall and a bottom portion 5. As shown in FIG. 2, the bottom portion 5 of the container preferably includes some raised nodes 51 having different sizes. Raised nodes 51 function to massage the feet upon contact, and also allow water or heat to flow under the feet to improve blood circulation of the feet.

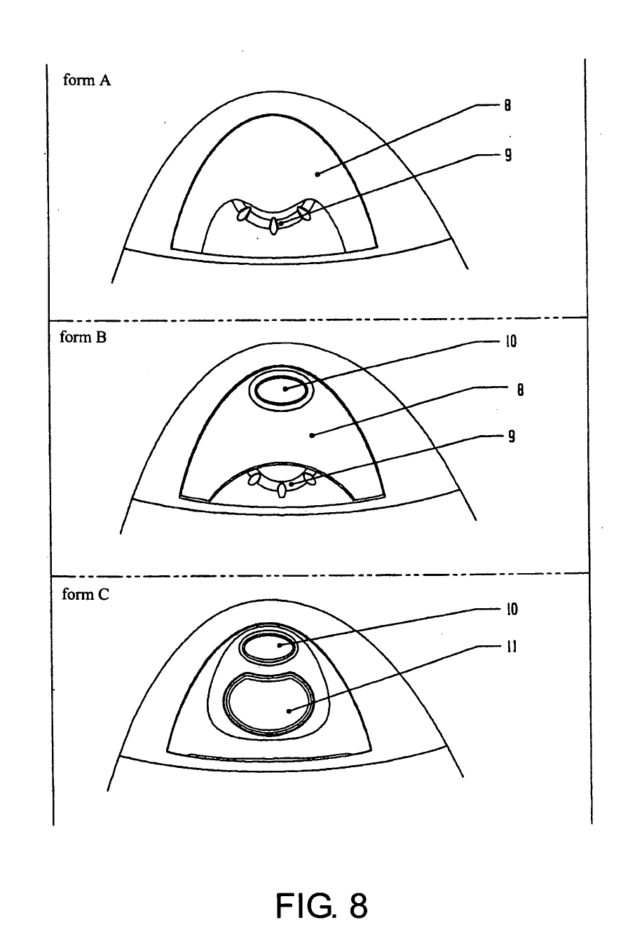

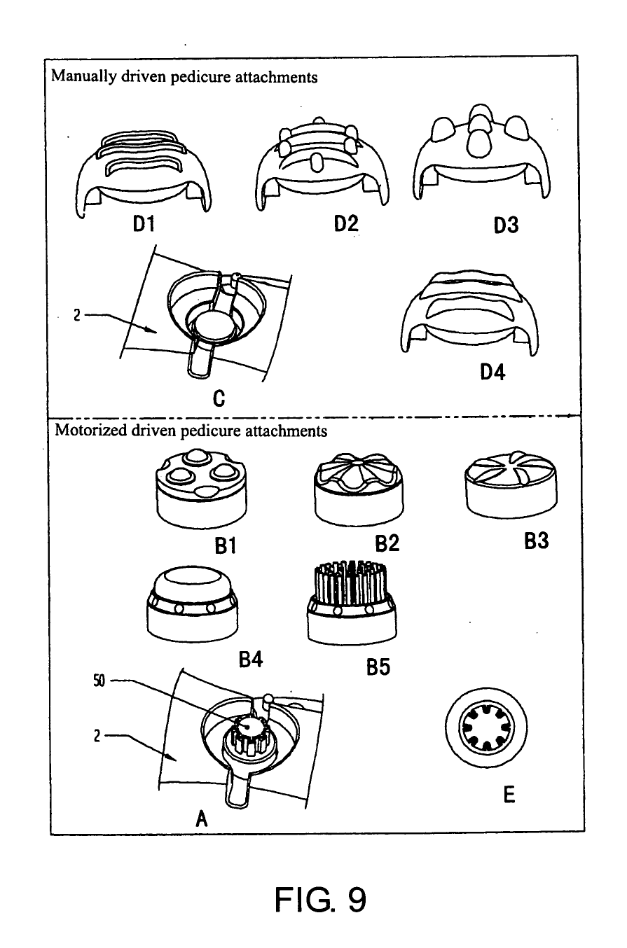

With reference to FIGS. 1-4, a selection switch 8, which is located on the outside of the foot seat 2, allows the user to select the various combinations of the foot caring and massage functions. With reference to FIG. 8, the selection switch 8 can be set to select three (A, B, & C) different combinations of foot caring functions:
1) Vibration+Heat+Motorized Massage;
2) Bubble+Heat;
3) Vibration+Heat+Bubble+Motorized Massage.

Further, the rotating head 50 provided at the rear end of the foot seat can fit over various rotatable massage attachments (pedicure attachments) 42 as desired. The rotation of the massage attachments 42 is started when the feet activate the massage attachments 42 by pressing. In addition, the rotatable massage attachments 42 can be shapes as bossed disc, impeller, vane wheel, flat disc or brush. The motorized rotation of the rotatable massage attachments 42 is started by pressure when the feet contact the massage attachments 42, but the rotatable massage attachments 42 can also be rotated manually by friction between the sole and the rotatable massage attachments 42. There are provided a motor 20, a transmission gear 48 and a switch 49 under the foot seat 2 so as to rotate the rotatable massage attachments 42 via an output shaft and a clutch 35.

The selection switch 8 can be a rotary switch 9 or a button switch 10 and 11, or the combination of the two types of switch. Further, the motorized driven system is provided to achieving the motorized rotation to the massage attachments such as roller attachment 36, and disc-shaped massage attachments 42.

With reference to FIGS. 2, 4 and 5, an air pump 15 located at the bottom portion of the container 4 directs the compressed air into water contained in the container 4 through gas tube, V-type tube 17 and holes 18 formed in the massage ribs, thereby generating air bubbles in the water. Heating means 14 is located under the bottom portion 5 of the container 4. The heating means preferably is electric heating wire, which is arranged to substantially cover the bottom portion 5 of the container 4, thereby heating the water in the container 4 and maintaining the water at a certain temperature.

With reference to FIGS. 1-4, the raised nodes 51 provided on the foot seat 2 and the raised nodes 51 provided on the bottom portion 5 of the container 4 can provide massage function to the feet. Further, stone massage means 13 provided at the front end of the foot seat 2 can provide stone therapy function to the feet. The stone massage means 13 can be of any shape, but preferably be of oval shape.

Further, the motorized foot caring and massage device comprises a vibration assembly 19 provided under the bottom portion 5 of the container 4. The vibration assembly 19 comprises an eccentric boss 21 provided on the output shaft of the motor 20 so as to transmit the generated vibration to the raised nodes 51 located at the bottom portion 5 of the container 4, the raised nodes 51 and the stone massage means 13 provided at the front end of the foot seat.

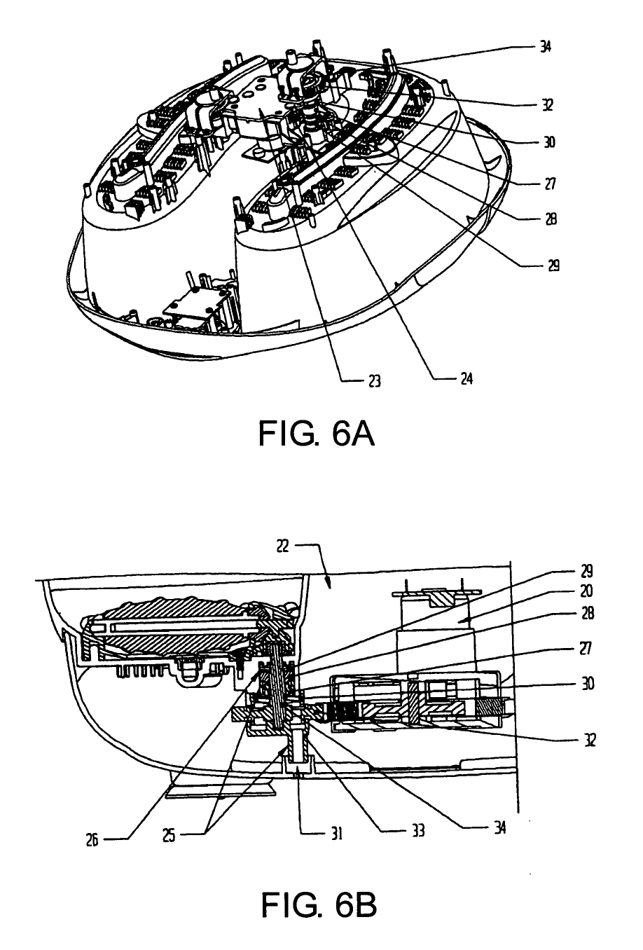

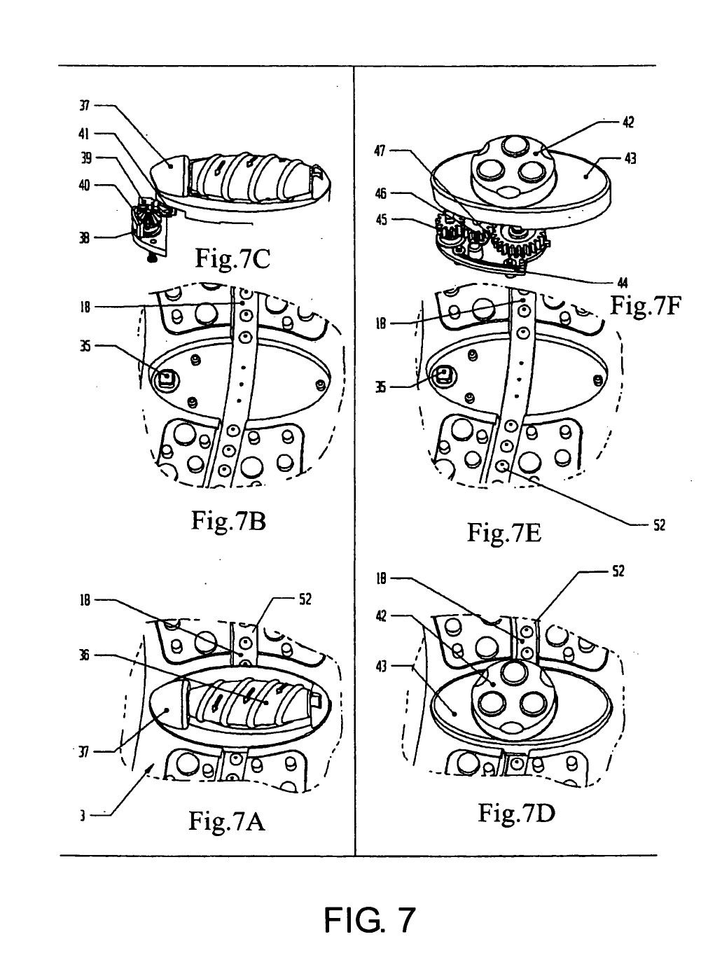

With reference to FIGS. 2, 4 and 7, there are provided massage ribs 52 at the bottom portion 5 of the container 4. Additionally, there are provided detachable and rotatable massage attachments 36 and 42 which are provided on a pedicure attachment bracket 43. As shown in FIGS. 6 and 7, the motorized foot caring and massage device comprises a motorized driven system 22 provided under the bottom portion 5 of the container 4. The motorized driven system 22 comprises a motor 20 and a gear system consisting of gears 23 and 24 for rotate the output shaft 34 and a clutch 35 so as to achieving the motorized rotation of the rotatable massage attachment 36 and 42.

With reference to FIGS. 7B and 7E, the clutch 35 is connected to the output 34 (FIG. 6A) so as to provide motorized rotation of the gears 45, 46 and 47 which are provided within the pedicure attachment bracket 43 and held by the gear holder 44, and to transmit the motorized rotation to the rotatable massage attachments 36 and 42 via the gears, thus providing massage to the feet. Additionally, as shown in FIGS. 7B and 7C, the clutch 35 is connected to the output 34 (FIG. 6A) so as to provide motorized rotation of the bevel gears 40 and 41 which are provided within the roller attachment bracket 37 and held by the bevel gear holder 38 and the pin 39, and to transmit the motorized rotation from the clutch 35 to the roller attachments 36 via the bevel gears, thus providing massage to the feet. With reference to FIG. 8, there is a separate ON/OFF switch 10 above the selection switch 8, which can perform ON/OFF control of the rotatable massage attachments 36 and 42.

As shown in FIG. 6, a double safety system 25 is provided under the bottom portion 5 of the container 4, and comprises a sealing system 26 and a drainage system 32. The sealing system 26 comprises a front seal 27, a bearing 28, a back seal 29 and a seal plate 30, and is used for maintaining the output shaft 34 rotation and sealing under normal condition. The drainage system 31 comprises a gear 32 and a gear holder 33, and is used for preventing water contained in the container from leaking and entering into the means provided under the bottom portion of the container in case of failure of the sealing system 26.

Further, as shown in FIG. 1, rubber feet 7 are provided at the bottom side of the housing 1, for supporting the massage device. The rubber feet 7 are fastened to the bottom side of the housing.

1. A motorized foot caring and massage device, comprising a container provided in a housing, the container having a bottom portion and used for containing water; an air pump, heating means, a vibration assembly and a motorized driven system being provided under the bottom portion of the container; and a function selection switch provided on the housing,
wherein raised nodes and massage ribs are provided on the bottom portion of the container for providing reflexology massage to the sole of the feet, and rotatable massage attachments which are replaceable as desired are provided in the recess formed on the bottom portion of the container;
the air pump directs air into the container through holes formed in the massage ribs, thereby generating air bubbles in the water contained in the container;
the heating means is used for heating the water contained in the container and maintaining a temperature of the water;
wherein an upwardly raised peninsular foot seat is provided at a central portion of the container, a combination of stone massage means and raised nodes is provided at a front end of a top portion of the foot seat, and the rotatable massage attachments which are replaceable as desired are provided at a rear end of the top portion of the foot seat;
wherein the motorized driven system includes a motor, an output shaft and a gear system driven by the motor, the motorized driven system is used for driving the rotation of the rotatable massage attachments provided at the bottom portion of the container and at the foot seat;
wherein the vibration assembly includes an eccentric boss provided on the output shaft of the motor, and is used for generating vibration and transmitting the vibration to the raised nodes provided at the bottom portion of the container and at the foot seat;
wherein a double safety system is provided under the bottom portion of the container, the double safety system includes a sealing system and a drainage system, the sealing system is used for maintaining the rotation of the output shaft and sealing under normal condition, the drainage system is used for preventing water contained in the container from leaking and entering into the means provided under the bottom of the container in case of failure of the sealing system;
the function selection switch is provided for selecting various combinations of foot caring therapy functions as desired.

2. The motorized foot caring and massage device according to claim 1, wherein the heating means comprises electric heating wires.

3. The motorized foot caring and massage device according to claim 1, wherein the rotatable massage attachments are of roller type or disc type.

4. The motorized foot caring and massage device according to claim 1, wherein the stone massage means is of oval shape and provided substantially at a center portion of the combination of the stone massage means massage means and the raised nodes.

5. The motorized foot caring and massage device according to claim 1, wherein the rotatable massage attachments provided on the top of the foot seat can be manually rotated by friction between a rear portion of a sole of foot and the massage attachments or be motorized rotated by the motorized driving system.

6. The motorized foot caring and massage device according to claim 1 or 4, wherein the rotatable massage attachments provided on the top of the foot seat have a shape of bossed disc, impeller, vane wheel, flat disc or brush.

7. The motorized foot caring and massage device according to claim 1, wherein the function selection switch is a rotary switch or a button switch.

8. The motorized foot caring and massage device according to claim 1 or 7, wherein the function selection switch can be used to select various combinations of the foot caring functions comprising Vibration+Heat+Motorized Massage, Bubble+heat or Vibration+heat+bubble+Motorized massage.

9. The motorized foot caring and massage device according to claim 1, further comprising a top cover made of transparent plastic material, which covers the massage device for protection when the massage device is not used.

10. The motorized foot caring and massage device according to claim 1, further comprising rubber feet at the bottom side of the housing for supporting the massage device, the rubber feet are fastened to a bottom side of the housing by screws.
